(19) United States
(12) Patent Application Publication
(10) Pub. No.: US 2024/0123443 A1
(43) Pub. Date: Apr. 18, 2024

(54) CONNECTION DEVICE

(71) Applicant: TREEFROG THERAPEUTICS, PESSAC (FR)

(72) Inventors: Clément RIEU, BORDEAUX (FR); Antoine REYNAUD, BORDEAUX (FR); Kevin ALESSANDRI, BOSTON, MA (US); Maxime FEYEUX, TALENCE (FR)

(21) Appl. No.: 18/347,008

(22) Filed: Jul. 5, 2023

(30) Foreign Application Priority Data
Jul. 13, 2022 (FR) 2207244

(51) Int. Cl. B01L 3/00

(52) U.S. Cl. CPC B01L 3/502715; B01L 2200/027; B01L 2300/08; B01L 2300/12

(57) ABSTRACT

A connection device between two micro-channels or two milli-channels of two fluidic elements including a complementary arrangement for holding the device with at least one of the two fluidic elements. A micro-fluidic or milli-fluidic chip including a connection device between a micro-channel or a milli-channel of the chip and a micro-channel or a milli-channel of a fluidic element.

### CROSS-REFERENCES TO RELATED APPLICATIONS

This application claims the benefit of the French patent application No. 2207244 filed on Jul. 13, 2022, the entire disclosures of which are incorporated herein by way of reference.

### BACKGROUND OF THE INVENTION

The present invention relates to the technical field of connection devices between two micro- or milli-channels of two fluidic elements. The invention also relates to a fluidic element comprising such a device.

### BACKGROUND OF THE INVENTION

The fluidic elements compatible with the present invention comprise opening channels, thus defining inlets and/or outlets capable of receiving another fluidic element. This then involves connecting two fluidic elements while maintaining an adequate flow between their respective channels. The flows relate to fluids that can be liquids and/or gases.

The technical field of microfluidics or millifluidics involves flows of liquids and/or gases in micrometric or millimetric channels. The dimension of the channels involved in microfluidics is on the order of tens and hundreds of microns, and for millifluidics it is on the order of a millimeter. This channel size entails specific flow rules, in particular in the case of laminar flow where it is important not to disrupt the flows. In addition, such a channel size may involve liquids available in small quantities, whose loss it is important to limit in micro-fluidic devices (namely in dead spaces).

In the above-mentioned field, it is known to connect two fluidic elements by pressure, by forcibly inserting a first fluidic element into the second. For example, a tube is forcibly introduced into an inlet of a micro-fluidic chip. In order to secure the connection, an adhesive can be placed beforehand or afterward on the tube/inlet assembly. However, this practice has several shortcomings, such as the risk of leakage, the low resistance to pressure, the risk of partial or total blockage of the channels, and the release of contaminant from the glue into the flowing fluids.

Another strategy consists of manufacturing the fluidic device with a standard male or female connector already included in the design (screw pitch, luer, etc.). Apart from the complexity of manufacturing this type of connector on the fluid device itself, this represents a non-negligible form factor, of the order of a centimeter, which may be problematic for the compactness of the device.

### SUMMARY OF THE INVENTION

The present invention aims to overcome these disadvantages by proposing a simple connection device that can be secured without using additional materials such as an adhesive.

Thus, the invention relates to a connection device between two micro-channels or two milli-channels of two fluidic elements comprising complementary means for holding the device with a dedicated outer surface of one of the two fluidic elements. The implementation of complementary means between the device and an outer surface of one of the two fluidic elements makes it possible to secure the connection between the two channels. The outer surface dedicated for a fluidic element corresponds to its end surface intended to be connected to a second fluidic element. In addition, with such a device, the connection between two fluidic elements is easier to implement.

Advantageously, the connection device is arranged so that the connection between the micro-channels or the milli-channels of the two fluidic elements is hermetic with respect to the external environment of these fluidic elements. Preferably, the connection device is arranged so that it opposes the penetration of solids, liquids and/or gases from outside the fluidic elements, through this connection, into one and/or other of the micro-channels or milli-channels; and to the leakage of solids, liquids and/or gases out from one and/or the other of the micro-channels or the milli-channels, through this connection, to the outside of the fluidic elements. It is thus ensured, using this connection device, that no contaminant can be introduced into the assembly of the fluidic elements, that the assembly is sterile and that its handling can be carried out under sterile conditions and environments. Therefore, the assembly finds particularly advantageous application in the health, pharmaceutical industry and biotechnology field.

According to a feature of the invention, the complementary holding means comprise at least one continuous barbed connector located in a dedicated cavity of a fluidic element, said barbed connector bearing on the dedicated outer surface of one of the two fluidic elements. The implementation of at least one continuous barbed connector ensures the sealing of the two connected fluidic elements. The device is thus present on an inlet or an outlet of a fluidic element directly concerned by the connection of the channels or the device is an external fluidic element ensuring the connection of two other fluidic elements. In addition, the barbed shape makes it possible not only to facilitate the insertion of the fluidic element, but also to prevent the fluidic element from being easily removed, in particular in the event of a rise in pressure. Finally, the barbed connector makes it possible to ensure sealing and pressure resistance.

According to another feature of the invention, the complementary holding means comprise at least two connectors that are parallel to one another, bearing on the dedicated outer surface of one of the two fluidic elements. The implementation of two barbed connectors makes it possible to increase the resistance to leaks and to tearing and also makes it possible to design a device comprising a discontinuous barbed connector.

According to one embodiment of the invention, the device or a first fluidic element comprises at least one barbed connector into a cavity and a second fluidic element comprises the dedicated outer surface. The device can thus be integrated into a fluidic element or be a third element allowing the connection of the first two. The barbed connector according to the invention is thus arranged in a cavity of a fluidic element. The implementation of a barbed connector in a cavity minimizes the dead space between the two fluidic elements. Thus, the device according to the invention allows better compactness of the connection itself, compared, for example, to existing connection devices of the “luer”, “luer lock”, or “luer slip” type. And, contrary to certain existing devices which require that the two fluidic elements be nested within one another, there is no change in diameter of one of the fluidic elements. The fluidic element that mates with the device can indeed be a standard tube.

According to one feature of the invention, the fluidic element that carries at least the barbed connector comprises a material more rigid than the second fluidic element. According to embodiments, the second fluidic element comprises an elastomeric material and the dedicated surface of the mating fluidic element deforms when inserted into the cavity carrying at least one barbed connector.

According to a feature of the invention, at least one barbed connector comprises a substantially polygonal profile. A polygonal shape makes it possible to effectively constrain the pressure of the inserted fluidic element. This embodiment increases the sealing of the coupling between the two fluidic elements.

According to one embodiment of the invention, at least one barbed connector comprises a substantially right-triangular profile. This profile shape is the most suitable for maintaining the connection.

According to one embodiment of the invention, one of the fluidic elements comprises a flexible tube or a semi-flexible tube or a rigid tube or a nozzle provided with a tip. These embodiments are the most common of the fluidic elements used.

According to another embodiment of the invention, one of the fluidic elements comprises a micro-fluidic or milli-fluidic chip. The device fits particularly well into an inlet or an outlet of a fluidic chip.

According to one feature of the invention, the device further comprises an additional external holding system. The implementation of an additional holding system makes it possible to secure the connection over time, in particular when the fluidic elements are intended to remain connected.

The invention also relates to a micro-fluidic or milli-fluidic chip comprising a connection device between a micro-channel or a milli-channel of the chip and a micro-channel or a milli-channel of a fluidic element.

The invention also relates to a connection bridge between two micro-channels or two milli-channels of two fluidic elements comprising complementary holding means of the device with the two fluidic elements.

Of course, the various features, variants and embodiments of the invention can be associated with one another according to various combinations insofar as they are not incompatible or exclusive of one another.

### BRIEF DESCRIPTION OF THE DRAWINGS

In addition, various other features of the invention will become apparent from the appended description given with reference to the drawings which illustrate non-limiting embodiments of the invention and wherein:

FIG. 1 is a sectional view of one embodiment of a device according to the invention,

FIG. 2 is a sectional view of another embodiment of a device according to the invention,

FIG. 3 is a sectional view of another example embodiment of a device according to the invention,

FIG. 4 is a perspective view of a fluidic chip comprising three devices according to the invention,

FIG. 5 is a sectional view of one embodiment of a device according to the invention, and

FIG. 6 is a schematic sectional view of a detail of a device according to the invention.

It should be noted that in these figures the structural and/or functional elements common to the different variants may have the same references.

### DETAILED DESCRIPTION OF THE PREFERRED EMBODIMENTS

The invention aims to propose a simple and sealed connection device between two micro-channels or two milli-channels of two fluidic elements. The fluids concerned are liquid, gaseous or mixed.

For these purposes, a device according to the invention as shown in FIG. 1 and designated as a whole by the reference 1 is used to connect two micro-channels or milli-channels 2 of the two fluidic elements 3a, 3b.

A fluidic element 3a, 3b compatible with the invention can be a flexible or semi-flexible tube, a rigid tube able to direct a flow, or a nozzle provided with a tip for the flow to pass through, or a micro-fluidic or milli-fluidic chip intended for different functions relating to the flow passing through, or a bridge able to connect two fluidic elements. This list is not exhaustive as to the use of the device 1 according to the invention.

According to one embodiment, in particular shown in FIG. 1, the device 1 allows the connection between two channels 2a, 2b respectively of two fluidic elements 3a, 3b. For elements relating to the micro-fluidic device, the channels are micro-channels comprising a diameter on the order of one micrometer and for elements relative to the millifluid, the channels are milli-channels with a diameter on the order of a millimeter. Subsequently, the flow of the fluidic elements moves along the direction Z.

In FIG. 1, the first fluidic element 3a, for example a fluidic chip, carries the device 1 according to the invention and the second fluidic element 3b is, for example, a semi-rigid tube intended to be connected to an inlet of the fluidic chip 3a.

The fluidic element 3, 3a which carries the barbed connector 10 can comprise various materials such as glass, plastic or composite materials or metal materials to mention only a few examples. In addition, according to certain embodiments of the fluidic element 3, 3a bearing the device 1, the barbed connector 10 may comprise materials different from those of the fluidic element 3, 3a concerned.

According to one embodiment, the barbed connector 10 comprises a material that is more rigid than the fluidic element 3b with which the barbed connector 10 mates. The fluidic element 3b intended to engage with the barbed connector may indeed comprise a more elastic material such as an elastomer or a composite mixture more elastic than the material composing the barbed connector 10.

According to the first embodiment shown in FIG. 1, the device 1 comprises a barbed connector 10 located in a cavity defining an inlet or an outlet of a fluidic chip 3a.

The inlet of the fluidic chip 3a and the tube 3b have a substantially cylindrical shape and substantially comprise a diameter of the same length. The tube 3b is intended to be introduced into the inlet of the fluidic chip 3a. Thus, the barbed connector 10 in the form of an extra thickness is pressed against the dedicated outer end surface of the tube 3b. The barbed connector 10 is a continuous extra thickness. Exemplary embodiments of a barbed connector 10 are described below.

According to other embodiments, the device 1 is intended to connect two fluidic chips 3a, 3b, one of the chips 3b then comprises a dedicated part having substantially the shape of a through tube comprising a dedicated outer surface able to mate with a dedicated inner surface of the cavity defining an inlet or outlet of the other chip 3a.

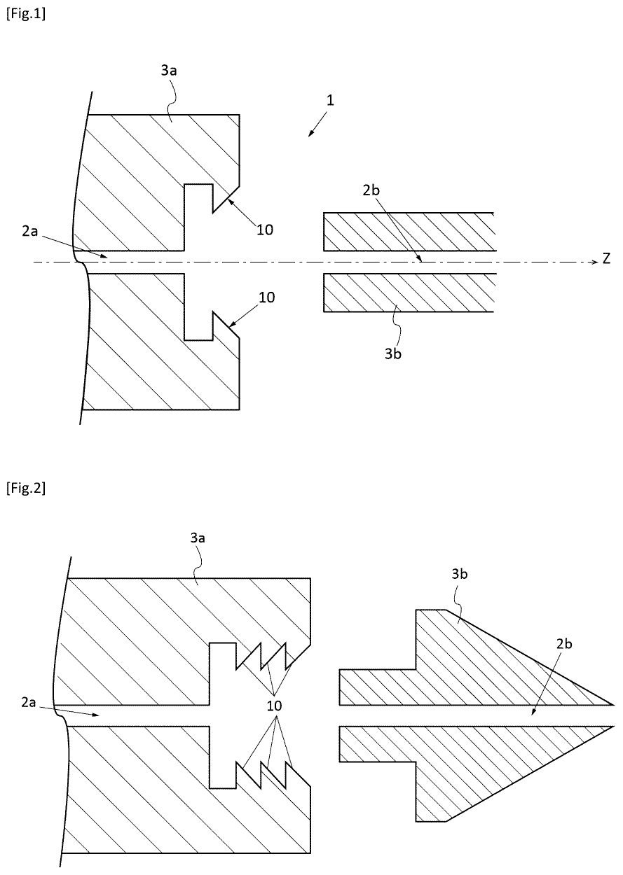

FIG. 2 shows an embodiment of the device 1 comprising three continuous and mutually parallel barbed connectors 10.

According to one embodiment of the invention, the device 1 comprises at least one continuous barbed connector 10 and can also comprise at least one other discontinuous connector 10 that is discontinuous parallel to the continuous barbed connector 10. Such a discontinuous connector 10 is in the form of a successive arc, for example in three parts.

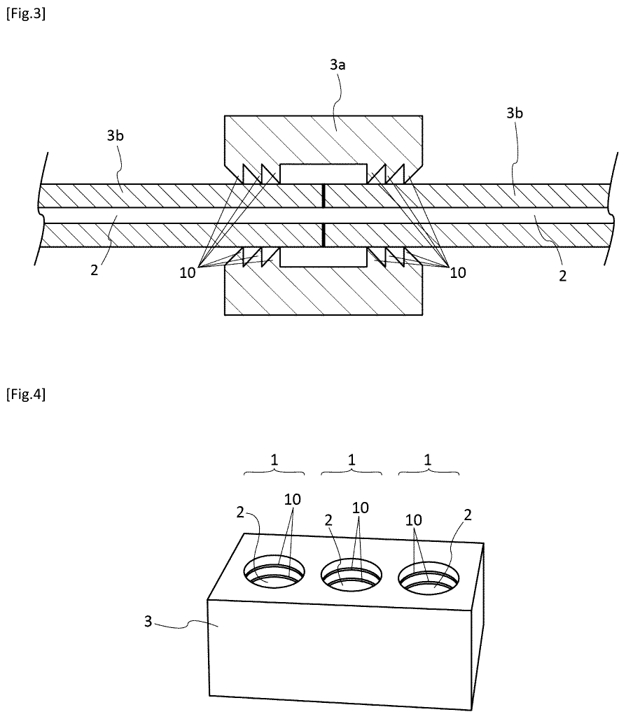

FIG. 3 shows an alternative embodiment of the invention, in particular intended for connection between two flexible or semi-flexible or rigid tubes 3b. For these purposes, the fluidic element 3a is a connection bridge that has substantially the shape of a hollow cylinder carrying two devices 1 according to the invention. Each device 1 is intended to be opposite a fluidic element 3b. Visible in FIG. 4, the two devices 1 implemented are symmetrical relative to the plane passing through the center of the first fluidic element 3a and normal to the fluid flow direction Z. This embodiment is not limiting for the invention and the fluid connection bridge 3a can carry two devices 1 of different shapes.

FIG. 4 shows a fluidic chip comprising three devices 1 according to the invention. Each of the three visible inputs or outputs of the fluidic chip 3 is able to be connected by means of a device 1 with another fluidic element 3b (not shown) in order to ensure continuity and guarantee the reliability of the flow between the various elements.

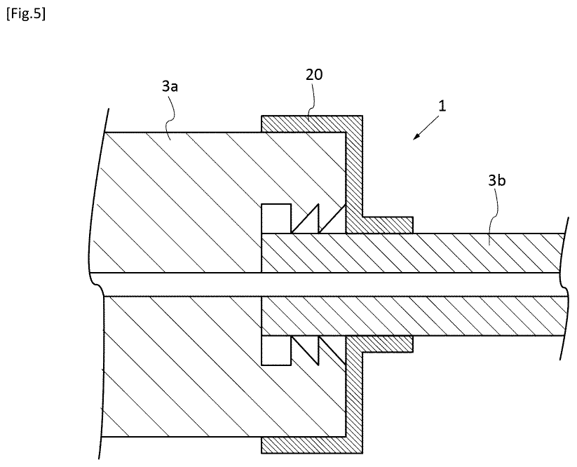

An additional external holding system is shown in FIG. 5. This is, for example, an adhesive tape 20 arranged around the connection between the two fluidic elements 3a, 3b. Other additional holding systems can increase connection security.

A barbed connector 10 compatible with the invention has an extra thickness in the inner surface of the cavity defining an inlet or an outlet of a fluidic element 3, 3a.

According to the embodiment shown in FIG. 4, the barbed connectors 10 are continuous, meaning that is it has the shape of a continuous ring of excess thickness on the inner surface of the inlets or outlets of the fluidic chip 3.

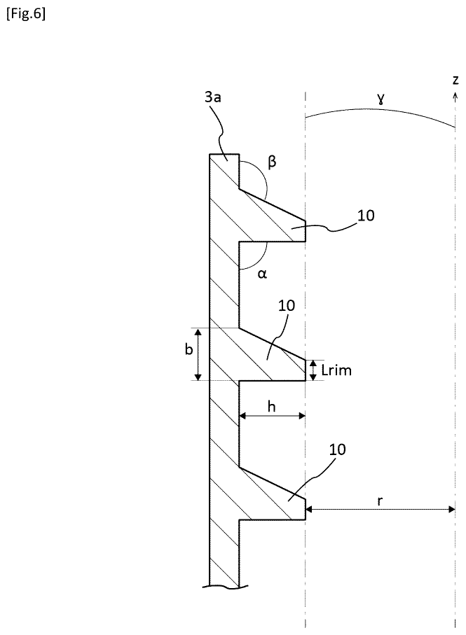

FIG. 6 schematically shows the profile of a device 1 comprising several barbed connectors 10. This profile is of substantially triangular shape comprising a flat part Lrim at its apex. A first angle β defines the profile of the barbed connector 10. This angle β is present on the side intended to receive the fluidic element 3b. The angle α is opposite the first angle β. The length h corresponds to the height of the barbed connector 10. The length b defines the spacing between two barbed connectors 10. The length r defines the internal radius of the inlet or the outlet of the fluidic element 3a bearing the device 1 according to the invention, that is half of the value of the diameter of said inlet or outlet. And the angle γ defines a reduction angle between the direction formed by the successive ridges of the barbed connectors 10, in the case where the height h of each of the barbed connectors 10 increases, and the direction Z corresponding to the direction of insertion of the second fluidic element 3b.

According to one embodiment of the invention comprising four crossed connectors 10 located on a fluidic element inlet 3a comprising a diameter of between 1.48 and 1.58 mm. The angle α is between 60 and 90°. The angle β is between 135 and 140°. The height of each barbed connector is between 0.15 and 0.31 mm. These value ranges are compatible with the invention in this embodiment.

According to this embodiment, the angle γ can vary between 0 and 7.78°. Preferably, the angle γ is close to zero.

This embodiment is not limiting for the invention. Indeed, and, in particular, for connecting two micro-channels of two fluidic elements, other quantities are compatible with the invention.

Of course, various other modifications can be made to the invention within the scope of the appended claims.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1-12. (canceled)

13. A connection device between two micro-channels or two milli-channels of two fluidic elements comprising complementary holding means of the connection device with an external dedicated surface of one of the two fluidic elements.

14. The connection device according to claim 13, wherein the complementary holding means comprise at least one continuous barbed connector located in a dedicated cavity of a fluidic element, said at least one barbed connector bearing on the external dedicated surface of one of the two fluidic elements.

15. The connection device according to claim 13, wherein the complementary holding means comprise at least two connectors that are parallel to one another, bearing on the external dedicated surface of one of the two fluidic elements.

16. The connection device according to claim 14, wherein the first fluidic element comprises the at least one barbed connector in a cavity and a second fluidic element comprises the external dedicated surface.

17. The connection device according to claim 16, wherein the fluidic element which carries at least the barbed connector comprises a material more rigid than the second fluidic element.

18. The connection device according to claim 14, wherein the at least one barbed connector comprises a substantially polygonal profile.

19. The connection device according to claim 18, wherein the at least one barbed connector comprises a substantially right-triangular profile.

20. The connection device according to claim 13, wherein one of the two fluidic elements comprises a flexible tube or a semi-flexible tube or a rigid tube or a nozzle provided with a tip.

21. The connection device according to claim 13, wherein one of the two fluidic elements comprises a micro-fluidic or milli-fluidic chip.

22. The connection device according to claim 13, further comprising an additional external holding system.

23. A micro-fluidic chip or a milli-fluidic chip comprising a connection device according to claim 13 between a micro-channel or a milli-channel of the respective micro-fluidic chip or milli-fluidic chip and a micro-channel or a milli-channel of a fluidic element.

24. A connection bridge between two micro-channels or two milli-channels of two fluidic elements comprising two connection devices according to claim 13, each device being connected to one of the two fluidic elements.
